(19) United States
(12) Patent Application Publication
(10) Pub. No.: US 2002/0092459 A1
(43) Pub. Date: Jul. 18, 2002

(54) Indicator light collector

(76) Inventor: Chiu-Chung Yang, Taichung (TW)

Correspondence Address: DAVID E. DOUGHERTY, DENNISON, SCHULTZ & DOUGHERTY, 612 CRYSTAL SQUARE 4, 1745 JEFFERSON DAVIS HIGHWAY, ARLINGTON, VA, 22002, US

(21) Appl. No.: 10/006,247

(22) Filed: Dec. 10, 2001

(30) Foreign Application Priority Data
Jan. 17, 2001 (TW) 090200883

(51) Int. Cl. F21S 10/00

(52) U.S. Cl. 116/202

(57) ABSTRACT

The indicator light collector includes a body, a first reflecting portion, a second reflecting portion, a lighting device, a circuit unit, a third reflecting portion, and a pattern portion. The body is formed by a transparent material. The first reflecting portion and second reflecting portion are installed at two lateral side of the body. The lighting device is received in a hollow receiving space being formed between the body and the first reflecting portion. The circuit unit is connected to a power source and the lighting device. The third reflecting portion is disposed on the surface of the body for reflecting the light refracted from the surface of the body. By the first, second and third reflecting portions, the indicator is more bright and is easily sensed the pattern portion disposed at the indicator by human eyes.

### FIELD OF THE INVENTION

The present invention relates to indicators, and particularly to an indicator light collector which is used in public places for indicating the people to move away from a desired path.

### BACKGROUND OF THE INVENTION

The prior indicators used in hospitals, theaters, or other public places are installed by a bottom plate and a circuit thereabove, and a lamp tube. Generally, an indicating pattern covers the sides of the indicators. The patterns are texts and drawings so as to indicate a desired direction to people to move along the desired path, which is especially used in emergency.

However, the prior indicator has a lighting device which is installed in a hollow space larger than the volume thereof and is spaced with texts and figures so that the illumination is weak. However, in emergency, for example fire accident, the environment will become dark, and thus it is often that people cannot clearly see the indications.

Furthermore, the lighting device of the prior indicator is installed at a bottom and is then locked by screws. Therefore, the assembly work is inconvenient.

### SUMMARY OF THE INVENTION

Accordingly, the primary object of the present invention is to provide an indicator light collector which is used in public places for indicating the people to move away from a desired path.

To achieve the object, the present invention provides an indicator light collector including a body, a first reflecting portion, a second reflecting portion, a lighting device, a circuit unit, a third reflecting portion, and a pattern portion. The body is formed by a transparent material. The first reflecting portion and second reflecting portion are installed at two lateral sides of the body. The lighting device is received in a hollow receiving space. The third reflecting portion is installed by an inner light-reflecting layer and an outer light-reflecting layer. The inner light reflecting layer covers the lower surface of the body; and the outer light reflecting layer is installed in the outer side of the inner light reflecting layer. By the first, second and third reflecting portions, the indicator is more bright and is easily sensed by human eyes.

The various objects and advantages of the present invention will be more readily understood from the following detailed description when read in conjunction with the appended drawing.

### BRIEF DESCRIPTION OF THE DRAWINGS

FIG. 1 is an exploded perspective view of the first embodiment of the present invention.

FIG. 2 is an exploded perspective view of the second embodiment of the present invention.

FIG. 3 is an exploded perspective view of the third embodiment of the present invention.

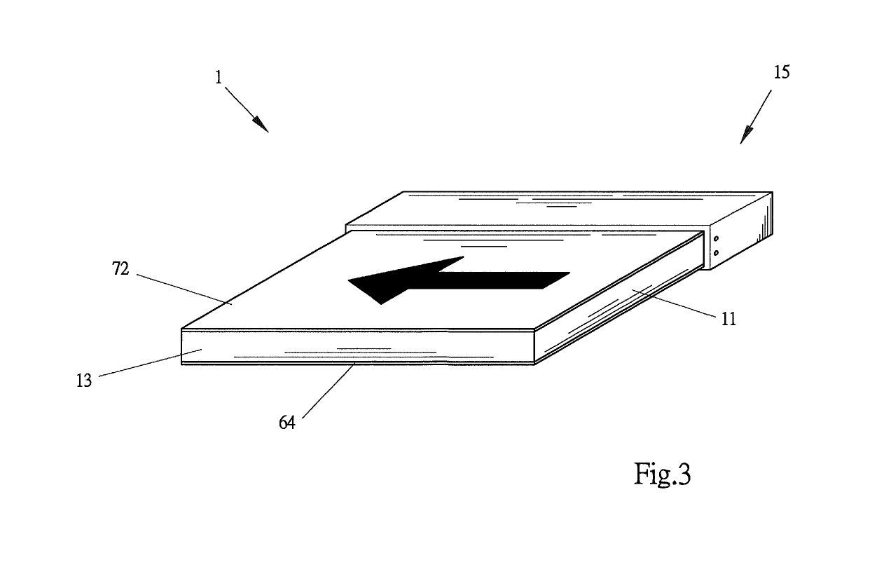

FIG. 4 is an exploded perspective view of the fourth embodiment of the present invention.

FIG. 5 is an exploded perspective view of the fifth embodiment of the present invention.

FIG. 6 is an exploded perspective view of the sixth embodiment of the present invention.

FIG. 7 is an exploded perspective view of the seventh embodiment of the present invention.

FIG. 8 is an exploded perspective view of the eighth embodiment of the present invention.

### DETAILED DESCRIPTION OF THE PREFERRED EMBODIMENTS

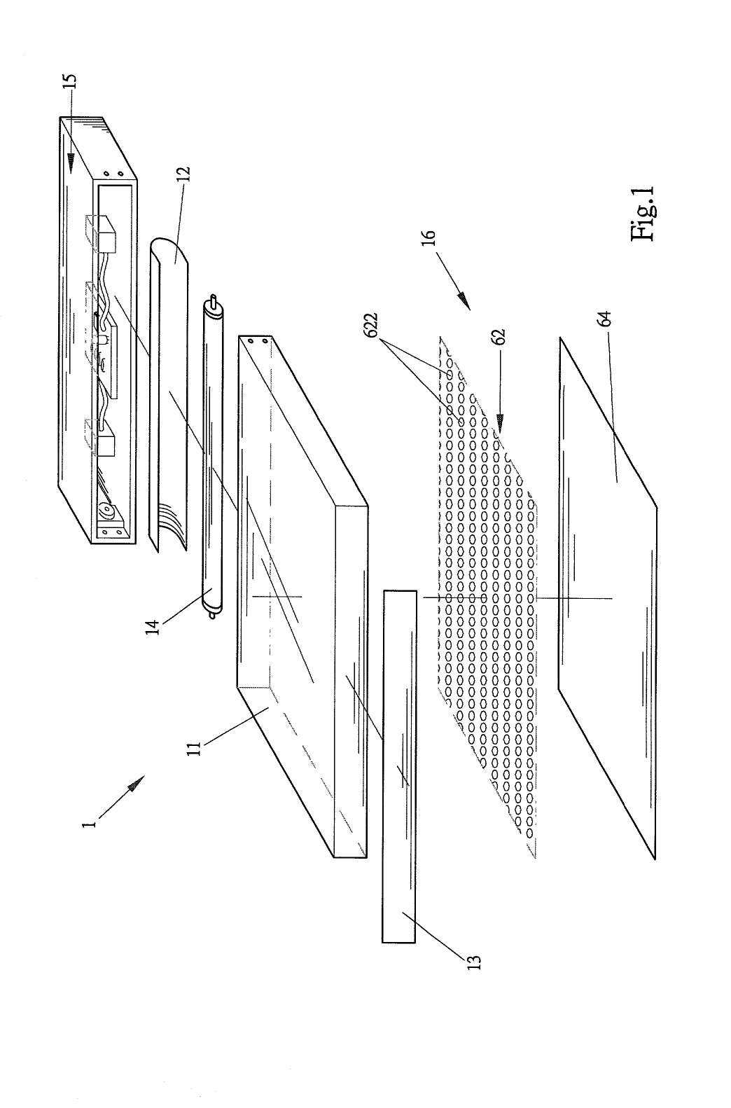

Referring to FIG. 1, the indicator light collector of the present invention is illustrated. The indicator light collector 1 includes a body 11, a first reflecting portion 12, a second reflecting portion 13, a lighting device 14, a circuit unit 15, a third reflecting portion 16, and a pattern portion 17.

The body 11 is formed by a transparent material, has a predetermined width and is a polygonal solid body.

The first reflecting portion 12 is a piece-like body with a predetermined shape. Two ends thereof are firmly secured to the periphery of the body 11 so as to be formed with a hollow receiving space with the body 11. The lateral side corresponding to the body 11 is a light-reflecting surface.

The second reflecting portion 13 is a piece like body with a predetermined shape. The second reflecting portion 13 is disposed at the periphery of the body 11 corresponding to the first reflecting portion 12. The lateral side corresponding to the body 11 is a light-reflecting surface.

The lighting device 14 is a fluorescent lamp, a cold cathode tube or a plurality of light-emitting diode and is embedded into the hollow receiving space.

The circuit unit 15 is formed by a package packing a plurality of circuit elements, and then is connected to a power source and the lighting device 14 through conductive wires or conductive joints so as to be installed at a predetermined portion at the periphery of the body 11.

The third reflecting portion 16 is disposed on the lower surface of the body 11 for reflecting the light refracted from the lower surface of the body 11. The third reflecting portion 16 is formed by an inner light-reflecting layer 62 and an outer light-reflecting layer 64.

The inner light-reflecting layer 62 is formed by a plurality of reflecting materials 622 which have predetermined thickness and shape like round points and covers the lower surface of the body 11.

The outer light-reflecting layer 64 has a piece-like body having a predetermined shape and is installed on the outer side of the inner light-reflecting layer 62. The lateral side of the outer light-reflecting layer 64 corresponding to the body 11 is a light-reflecting surface.

The pattern portion 17 is installed at the structure of the present invention for showing to the peoples. The way for installation will be described in the following.

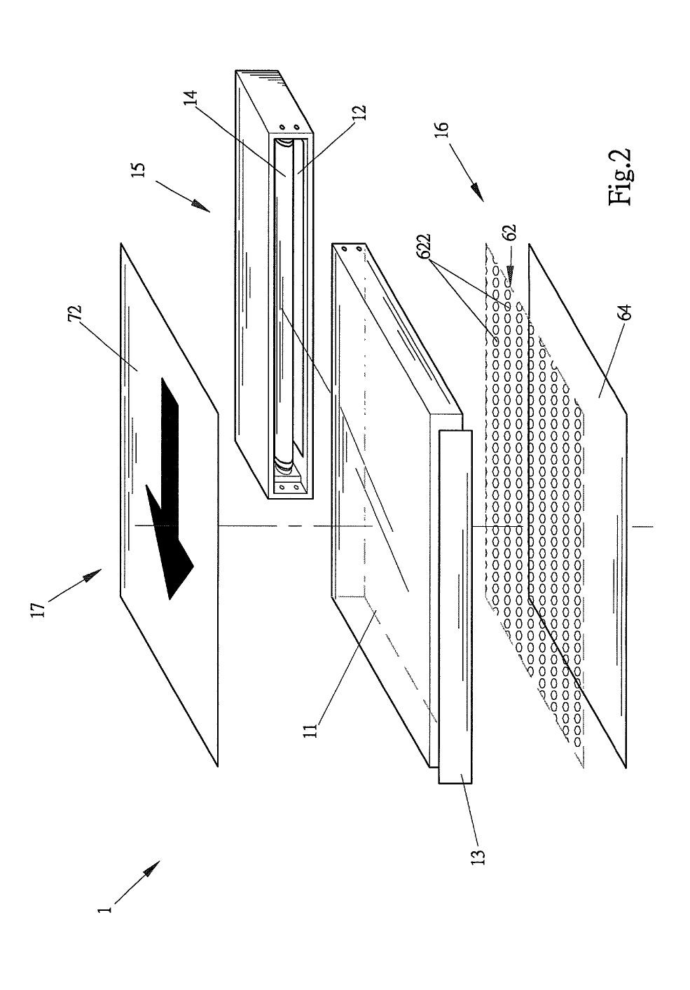

A. Referring to FIG. 2, the pattern portion 17 is a drawing with predetermined texts or figures being adhered to or printed on a piece-like body 72. Then, the piece-like body 72 covers the upper surface of the body 11. The drawing is different from the piece-like body 72 in optics or color.

B. The pattern portion 17 is an opaque layer being adhered to or printed on the piece-like body covers the upper surface of the body 11. The opaque layer has a predetermined thickness and is hollowed with predetermined texts or figures. (not shown in the figures of the embodiment)

C. The pattern portion 17 is a drawing with predetermined colored texts or figures being adhered or printed to the upper surface of the body 11. (not shown in the figures of the embodiment)

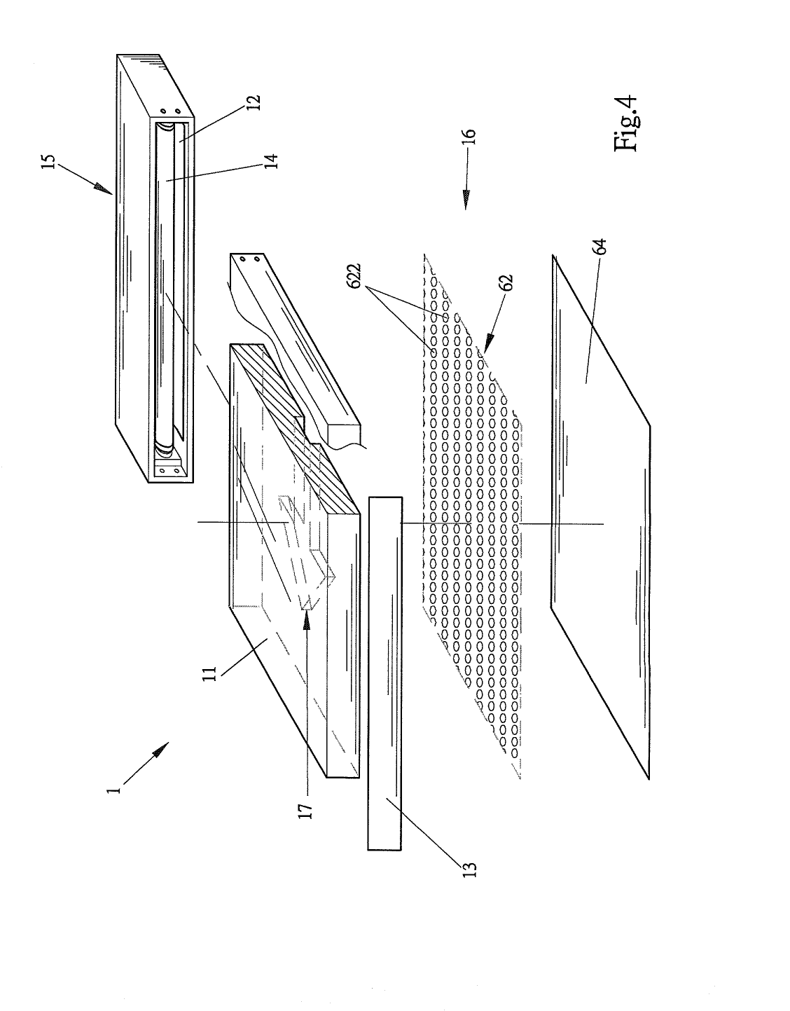

D. Referring to FIG. 4, the pattern portion 17 is formed by engraving texts or figures on the upper surface or lower surface of the body 11; moreover, the pattern portion 17 may be colored. Therefore, the light from the pattern portion 17 and the light from the body 11 out of the pattern portion 17 are different in optics or color.

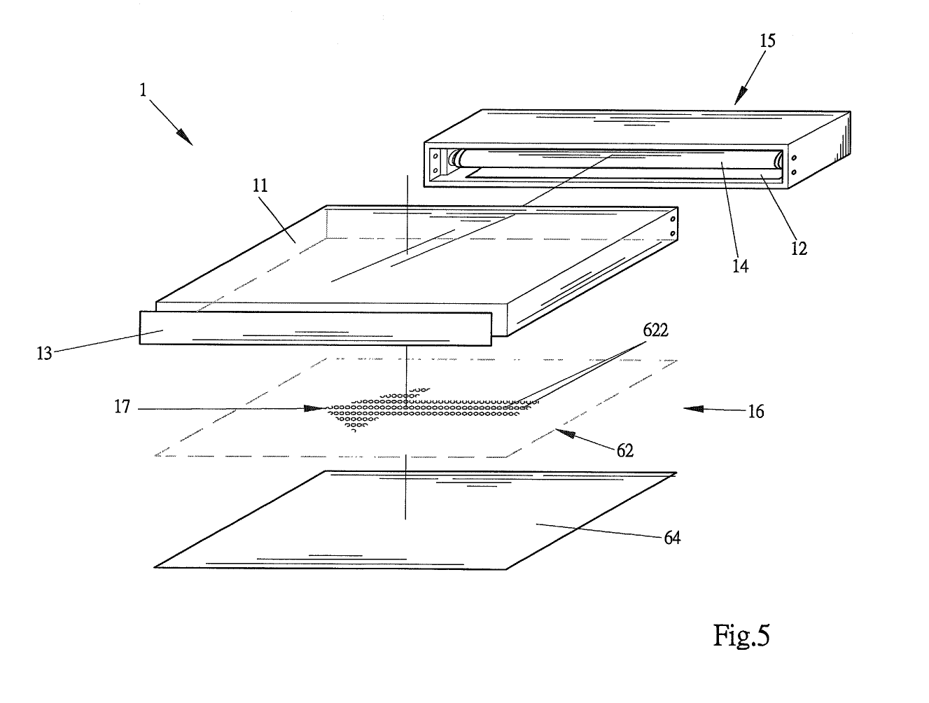

E. Referring to FIG. 5, the pattern portion 17 is formed by the reflecting materials 622 which are arranged as predetermined texts or figures. The inner light reflecting layer 62 is colored and is different in color with the reflecting surface of the outer light reflecting layer 64.

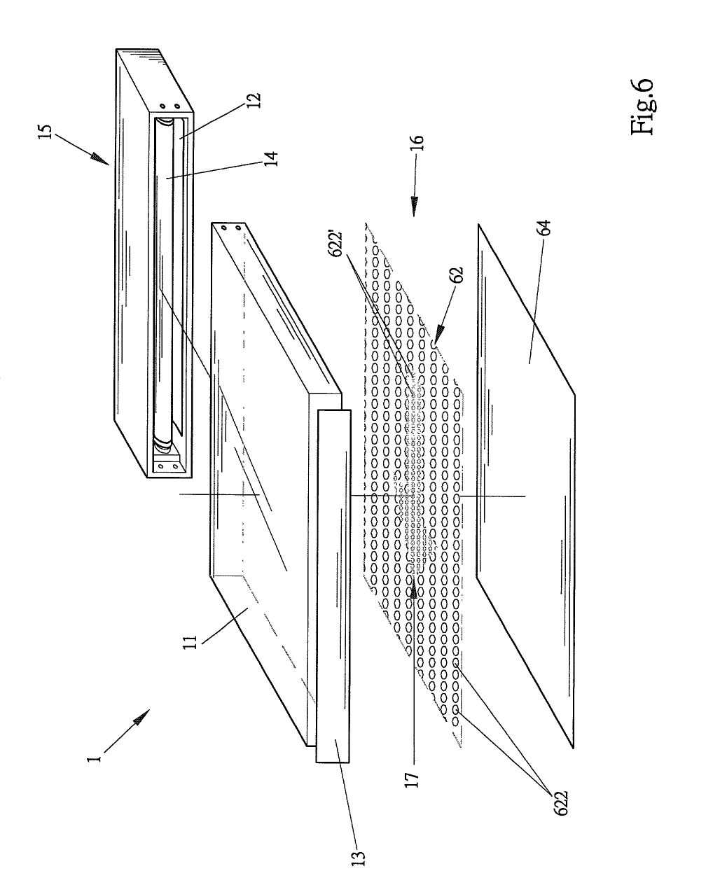

F. Referring to FIG. 6, the pattern portion 17 is formed by the some of the reflecting materials 622′ of the reflecting materials 622 which are arranged as predetermined texts or figures. The reflecting materials 622′ is different in optics or color with the reflecting materials 622 and the light-reflecting surface of the outer light-reflecting layer 64.

G. In the structure of E and F, the outer light-reflecting layer 64 is not installed, and the reflecting materials 622 of the inner light-reflecting layer 62 are arranged to be spaced with one another. Light may pass through from the lower surface of the body 11 so that both two sides of the present invention have indication function.

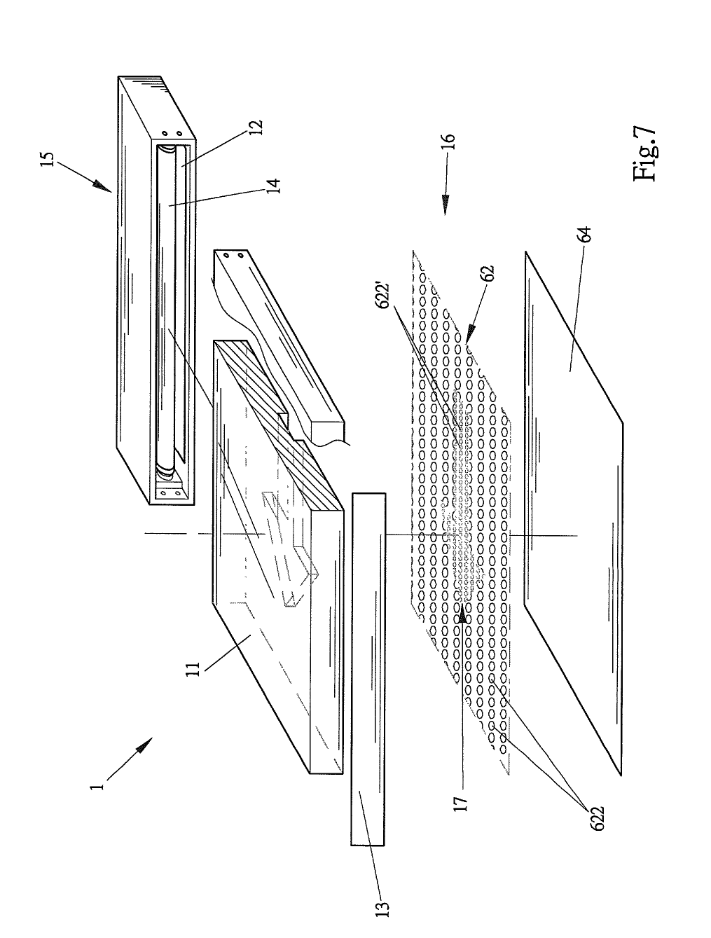

H. Referring to FIG. 7, in the structures of E and F, the lower surface of the body 11 is engraved with texts or figures having a predetermined depth and corresponding to the above said texts or figures. Therefore, light can be collected effectively and the illumination of the pattern portion 17 is increased.

The body 11 is a transparent solid body and the lighting device 14 is installed at the periphery of the body 11. Most of the light from the lighting device is guided to the interior of the body 11. Furthermore, by the first reflecting portion 12 and the second reflecting portion 13, the light of the lighting device 14 is further collected in the interior of the body 11. Moreover, by the third reflecting portion 16 installed on the lower surface of the body 11, most light is guided to the upper surface of the body 11.

The indicator light collector 1 of the present invention has the following advantages.

1. Light from the lighting device 14 can be used effectively so as to have a preferred gray level and contrast effect.

2. By the texts or figures engraved on the body 11, light can be collected so as to increase the illumination of the pattern portion 17.

3. In the G of the pattern portion 17, the present invention can be installed at the intersection of two paths so that the people in front or rear sides of the body 11 may see the pattern, and thus the cost is reduced.

In the H of the pattern portion 17, the texts or figures can be engraved on the upper surface of the body 11.

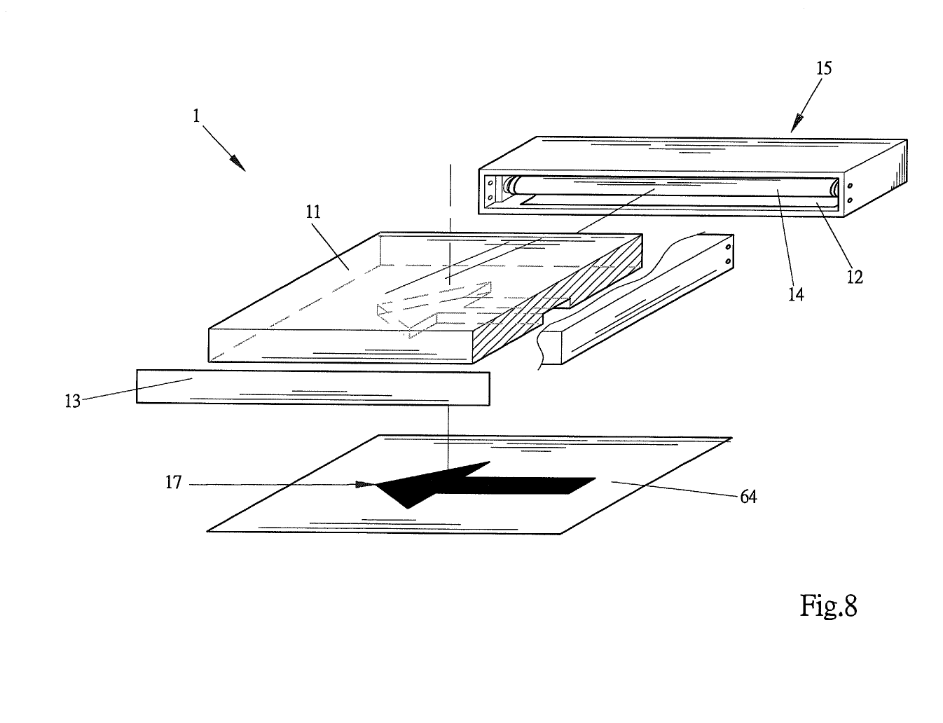

Referring to FIG. 8, in the structure of the present invention, the third reflecting portion 16 has no inner light-reflecting layer 62. In the installation of the pattern portion 17, the reflecting surface of the outer light-reflecting layer 64 has predetermined texts or figures. The area of the pattern portion 17 and the reflecting surface of the outer light-reflecting layer 64 out of the pattern portion 17 are different in optics and color. Furthermore, the lower surface of the body 11 corresponding to the texts or figures is engraved with the texts or figures.

In the above structure, if the pattern portion 17 is not installed, then the present invention can be used an emergency illumination.

A hollow frame encloses the periphery of the structure of the indicator light collector 1.

In the above structure, in the circuit elements on the circuit unit 15, a battery is installed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An indicator light collector comprising:
a body being formed by a transparent material and being a polygonal solid body;
a first reflecting portion being a piece like body with a predetermined shape and being at a predetermined portion at the periphery of the body; the lateral side thereof corresponding to the body being a light-reflecting surface; and a hollow receiving space being formed between the first reflecting portion and the body;
a second reflecting portion being a piece-like body with a predetermined shape; the second reflecting portion being disposed at the periphery of the body corresponding to the first reflecting portion; the lateral side thereof corresponding to the body being a light-reflecting surface;
a lighting device being embedded into the hollow receiving space;
a circuit unit being formed a package packing a plurality of circuit elements, and then being connected to a power source and the lighting device through conductive wires or conductive joints so as to be installed at a predetermined portion at the periphery of the body; and
a third reflecting portion being disposed on the lower surface of the body for reflecting light refracted from the lower surface of the body.

2. The indicator light collector as claimed in claim 1, wherein the third reflecting portion is formed by a plurality of reflecting materials which have predetermined thickness and shape and are spaced with one another.

3. The indicator light collector as claimed in claim 1, wherein the third reflecting portion is a piece-like body having a predetermined shape and the lateral side thereof corresponding to the body is a reflecting surface.

4. The indicator light collector as claimed in claim 1, wherein the third reflecting portion is formed by an inner light-reflecting layer and an outer light-reflecting layer;
the inner light-reflecting layer is formed by a plurality of reflecting materials which have a predetermined thickness and shape and covers the lower surface of the body;
the outer light-reflecting layer has a piece-like body having a predetermined shape and is installed on the outer side of the inner light reflecting layer; and the lateral side of the outer light-reflecting layer corresponding to the body is a light-reflecting surface.

5. The indicator light collector as claimed in claim 1, further installed with a pattern portion; and
the pattern portion is a drawing with predetermined texts or figures being adhered to or printed on the upper surface of the body.

6. The indicator light collector as claimed in claim 1, further installed with a pattern portion;
the pattern portion is a drawing with predetermined texts or figures being disposed on a piece-like body; the piece-like body covers the upper surface of the body; and the drawing is different from the piece-like body in optics or color.

7. The indicator light collector as claimed in claim 1, further installed with a pattern portion; and
the pattern portion is formed by engraving texts or figures on the body.

8. The indicator light collector as claimed in claim 7, wherein the light from the pattern portion and the light from the body out of the pattern portion are different in optics or color.

9. The indicator light collector as claimed in claim 6, wherein the texts or figures are adhered to or printed on a predetermined portion of the piece-like body.

10. The indicator light collector as claimed in claim 1, further comprising a pattern portion; and
the pattern portion is an opaque layer with a predetermined thickness and the opaque layer is hollowed with predetermined texts or figures.

11. The indicator light collector as claimed in claim 2, further comprising a pattern portion;
the pattern portion is formed by the some of the reflecting materials which are arranged as predetermined texts or figures; and the reflecting materials of the pattern portion are different in optics or color with the other reflecting materials.

12. The indicator light collector as claimed in claim 3, further comprising a pattern portion; and
in the pattern portion, the reflecting surface is disposed predetermined texts or figures, the area of the pattern portion is different from the reflecting surface out of the pattern portion in optics and color.

13. The indicator light collector as claimed in claim 4, further comprising a pattern portion;
the pattern portion is formed by the some of the reflecting materials of the inner light-reflecting layer which are arranged as predetermined texts or figures; and the reflecting materials of the pattern portion are different in optics or color with the other reflecting materials and the light-reflecting surface of the outer light-reflecting layer.

14. The indicator light collector as claimed in claim 11, wherein the lower surface of the body corresponding to the texts or figures is engraved with the texts or figures.

15. The indicator light collector as claimed in claim 12, wherein the lower surface of the body corresponding to the texts or figures is engraved with the texts or figures.

16. The indicator light collector as claimed in claim 13, wherein the lower surface of the body corresponding to the texts or figures is engraved with the texts an or figures.

17. The indicator light collector as claimed in claim 1, wherein the lighting device is one of a fluorescent lamp, a cold cathode tube and a light-emitting diode.

18. The indicator light collector as claimed in claim 1, wherein the circuit unit furthermore comprises a battery.

19. The indicator light collector as claimed in claim 1, wherein a hollow frame encloses the periphery of the structure of the indicator light collector.
